(19) United States
(12) Patent Application Publication
(10) Pub. No.: US 2014/0095399 A1
(43) Pub. Date: Apr. 3, 2014

(54) COMPETITION-BASED METHOD OF RANKING JOB CANDIDATES

(71) Applicant: MATTHEW J. SMITH, Louisville, KY (US)

(72) Inventor: MATTHEW J. SMITH, Louisville, KY (US)

(21) Appl. No.: 13/633,507

(22) Filed: Oct. 2, 2012

(51) Int. Cl. G06Q 10/10

(52) U.S. Cl. CPC G06Q 10/1053
USPC 705/321

(57) ABSTRACT

A software, web-based method enables employers to determine which candidates are the most talented as it relates to a specific job capabilities. It takes a pre-existing pool of job seekers and allows them to enter talent based competitions to win prizes, job interviews, and ultimately jobs. Employers then receive a list ranking the most talented candidates for any given job. Because there are prizes associated with contests, there are additional incentives to participate ensuring a higher volume of candidates for the position. The prizes attract candidates who would otherwise not have been interested in that particular job. This competition-based system will produce the best candidates that have the particular and specific skills necessary for the actual job and will allow the employer to actually see those skills in action during the selection process.

### BACKGROUND OF THE INVENTION

The present invention relates to a competition-based method of ranking job candidates. The present invention relates to a unique computerized human resources business process, delivered through proprietary software and/or the web that revolutionizes the way employers identify, filter, rate and select prospective job candidates, thereby dramatically decreasing candidate search time while simultaneously increasing the quality and accuracy of hiring process.

In the prior art, there are a number of web-based hiring platforms for employers to list jobs and job seekers to apply. Most of these job websites allow job seekers to enter traditional resume data and browse job listings based upon various filters. Those filters include type of job, job qualifications, geographic location, salary and keywords, among others.

Recently, job websites have begun introducing versions of what is known as a virtual resume. While there are various kinds of virtual resumes they all have a common goal of creating a more detailed and dynamic job seeker profile.

The major innovation of the present job sourcing universe is the ability to use social media to sort enhanced candidate profiles based on actual candidate attributes. The prior art merely allows employers to receive resumes and sort those candidates based on demographics, specific qualifications, experience or key words. Some of the more advanced website methods go so far as to use predictive algorithms to match candidates to job openings. However, none of the current methods use a job-specific competition application process to identify and rank interested top candidates based upon a dynamic method of highlighting actual skills relevant for the job in practice.

Contests or competitions, when employed, also exist in a vacuum in which an individual company promotes their own competition as a marketing or branding concept which produces “winners” who receive an internship (typically) or a job opportunity. Such contests are not designed around specific skills necessary for the job. The contests are mostly fun or creative in nature and are typically focused on the brand of the company. They are also fairly complicated and are costly for the employer. They are not systematic hiring methods but marketing methods for individual companies to promote their own brands.

The following prior art is known to Applicants.

Applicants are aware of six patents issued to Michael Lydon et al., namely, U.S. Pat. Nos. 6,569,012; 6,761,631; 6,824,462; 6,984,177; 7,300,346; and 7,311,595. These patents teach methods and apparatuses for providing a coding competition. In one example, such a method includes transmitting a coding problem to contestants, receiving computer code created by a contestant, determining a response of the computer code to test data, and evaluating the response of the computer code with respect to the test data. In another embodiment, a method of evaluating a skill level of a contestant includes electronically communicating a coding problem to contestants, electronically receiving a software program in response to the coding problem, evaluating the received software program, awarding points to the contestant based upon the value of the received software program, and subsequently determining a rating for the contestant during the competition based upon the number of points awarded as a result of evaluation of the software they have submitted.

The present invention differs from the teachings of the Lydon et al. patents in that the present invention is intended for users who are prospective employees to compete and showcase their employable skills before employers, other uses, and neutral judges. The present invention results in ranking of an order of job candidates based upon their relative levels of skill and talent with respect to one another. The present invention employs the use of social media tools to allow professionals, employers or users to evaluate and rank contest entries as opposed to the teachings of the Lydon et al. patents which employ an automated computer software system for ranking purposes. The present invention also combines an employment candidate's virtual profile as part of a contest entry to provide an additional mechanism to facilitate giving the employer information regarding the candidate prior to their interview and subsequent hiring. The present invention also differs from the Lydon et al. patents since they employ an automated system to evaluate computer code to determine winners of a contest, whereas the present invention uses an online voting system which is fundamentally different.

U.S. Pat. No. 7,321,858 to Andino, Jr. et al. discloses an integrated highly automated competition system that allows for selection of one or more competition winners. Documents can be submitted electronically or by hardcopy. Document submissions are checked against databases to determine duplicate existence by a variety of information extracted from the documents. Candidates are filtered by one or more filters requiring candidates meet completeness, qualification, eligibility, and partner/discretionary standards. Candidates are evaluated by one or more readers and scored on a plurality of cognitive and non-cognitive variables. Readers are monitored and corrective action is taken when reader evaluations are determined to require corrective action. Candidates are selected by a two stage process first using raw read scores and then using a successive weighted read score iteration or tie-breaking stage. Winning candidates are subject to progress tracking and re-qualification prior to receiving award payments.

The present invention differs from the teachings of Andino, Jr. et al. in the following respects:

First, the Andino, Jr. et al. process is designed to determine competition winners by using “Reader” evaluations based upon written entries. By contrast, the present invention uses online voting to determine a list of the talented job candidates based upon contest entries.

Second, the present invention uses an online platform to host and promote contests, whereas the Andino, Jr. et al. method is an automated mechanism for evaluating written contest submissions.

Third, the present invention allows multi-media forms of submission including pictures, drawings, audio and video submissions, whereas Andino, Jr. et al. is limited to written submissions. It is solely designed to use the written word as the evaluation criteria.

Fourth, Andino, Jr. et al. disclose a multi-stage selection process designed to use readers to select a candidate, whereas the present invention is a talent-based filtration process designed to create a ranked ordered list of candidates. The present invention employs other users and industry professionals to vote on the best entries creating the ranked list of best candidates.

Fifth, the present invention also combines a virtual profile as part of the submission process to help further select candidates for interview and hiring. Rewards vary including prize money and employer interviews.

Finally, in the present invention, the employer determines who is hired, not an automated system. Votes, rankings, and virtual profiles are used as a distillation tool.

U.S. Pat. No. 7,865,423 to Hughes et al. discloses methods and systems for providing investment competitions. In one aspect, trading algorithms that automatically generate trading instructions in response to market data are developed by and received from a distributed plurality of independent trading algorithm developers. The algorithms are periodically executed against market data and generate trading instructions, which, based on an association of investment accounts with the trading algorithms, initiate correlative trades in the investments accounts.

The present invention differs from the teachings of Hughes et al. in the following respects:

This patent discloses a specific system of stock trading competitions where the (“lucky”) winner is automatically determined by market performance. These competitions have all but disappeared because of the luck factor.

By contrast, the present invention is a skills-based competition and hiring platform for distilling a list of the most qualified candidates for a given position through various voting methods. The list is then evaluated further by accessing virtual profiles of the candidates to determine the best potential fits for an organization.

U.S. Pat. No. 8,001,057 to Hill discloses a method for grading a job seeker, relative to the universe of employed persons for a specified employment position, comprising the steps of establishing an interactive web site for remotely communicating with a user, displaying a series of queries to the user to survey a suitability of said user for a selected employment position, receiving input from said user in response to said queries, deriving a grade in relation to an index associated with a specific set of inputs in response to said queries, said grade reflecting a quantitative value of a suitability for a selected employment position, and displaying said grade within the context of the index, to said user, and system for carrying out said method.

The present invention differs from the patent to Hill in the following way:

Hill discloses an interactive website where the “job seeker” can interact with the employer. Employers and candidates can then have a more interactive relationship rather than just posting a job on a webpage. It is more of an online interview or personality testing process and not a competition. By contrast, the present invention allows employer and candidates to communicate, but the competitive skills-based process of distilling talent is not disclosed by Hill.

U.S. Published Application No. US 2012/0023031 A1 to Galya discloses business matching system and methods thereof for the creative arts industries. The invention relates to a business matching system and methods thereof. More specifically, embodiments of the present invention relate to a network-based system for matching a candidate with an open position of an employer within a predetermined creative arts industry and methods of utilizing and implementing the same. In one embodiment, a method of matching business personnel comprises: receiving, at administrator, candidate data comprising at least information pertaining to the candidate's professional abilities; receiving, at the administrator, employer data comprising at least information pertaining to the employer's employment needs; utilizing a processes; at the administrator, to compare the candidate data to the employer data based upon at leastone predetermined criteria; and enabling a virtual audition between the candidate and the employer upon determination of a positive match between the candidate data and the employer data.

The present invention differs from the teachings of Galya in the following respects:

First, the Galya concept is focused on performance arts only. Second, the Galya concept is fundamentally a database of performance art candidates with the ability to conduct virtual auditions (interviews for the performing arts). Third, the Galya project does not use social media tools to filter the best qualified candidates; and fourth, the Galya system is a matching system augmented with a virtual audition (interview) post candidate matching. The Galya system is not a competition based selection system. While Galya contemplates an audition-style system the selection is not based on a talent competition nor is there a voting system for distilling the best of the best talent as is the ease with the present invention.

U.S. Published Application No. US 2011/0276507 A1 to O'Malley discloses a system and method for recruiting, tracking, measuring, and improving applicants or candidates and any resources, qualifications, expertise, and feedback. O'Malley includes a memory device for storing the information regarding at least one resource, at least one resource criterion, at least one resource match, and at least one processing device for processing information regarding the information, criteria, resource and match. In one aspect, the processing device utilizes information regarding at least one job opening, an applicant's contract, an interviewer's available date, an interviewer available time, and an interview schedule, stored in the memory device, and further wherein the processing device generates a message containing information regarding at least one of a job opening, an interview schedule, an interviewer, an applicant's contract, a date and a time, wherein the message is responsive to the job interview request, and a transmitter for transmitting the message to a communication device associated with an individual in real-time.

The O'Malley system is completely different from the present invention. This system is designed to record, track and communicate a candidate's application process. This system has nothing to do with vetting top talent or distilling a list of the most qualified candidates based on a competition hiring method.

Applicants are also aware of the following Internet-based processes:

About.me Ultimate Internship Competition

Link: http://www.internmatch.com/blog/win-the-ultimate-paid-summer-internship-with-aboutmes-internship-challenge

Description: This one-time internship competition asked users to create an about.me profile demonstrating why they are the best candidates for one of five internships. Winners are selected by the most number of votes received from other users.

Differences: This one-time competition is not the same as competition based hiring method systematically used to determine the best candidates for a given position. Competition based hiring focuses on job-specific skills that users, professionals or employers evaluate and vote.

The About.me competition is won on the number of votes alone without regard to the candidate's actual ability to perform the job or internship. It is a contest and not a hiring method.

Glamour—Win! An internship at The Outnet

Link: http://www.glamourmagazine.co.uk/competitions/2012/03/outnet-work-experience-competition

Description: A contest that requires internship candidates to submit a 50 word entry telling Glamour why they are the best candidate for an internship.

Differences: This contest is typical of other one-time contests awarding winners with job or internship opportunities. The contest does not function as a systematic method for filtering and ranking the best candidates for a specific job or internship opportunity. The best 50 words (or similar contests) have no validity when it comes to skills required for the job.

Gradzone—Africhic Design Internship at Quirk Marketing

Link: http://www.africhic.com/brief

Description: Contest to design a new website for Africhic. The winner receives a 12 month paid internship at Quirk Marketing.

Differences: This contest is typical of other one-time contests awarding winners with job or internship opportunities. The contest does not function as a systematic method for filtering and ranking the best candidates for a specific job or internship opportunity.

Golfweek—Writing Contest: Win a Summer Internship

Link: http://golfweek.com/news/2012/apr/23/writing-contest-win-summer-internship/

Description: The theme for this year's contest is “Your ideal round of golf.” Candidates should provide an original, thoughtful essay (less than 800 words) describing their best round of golf (real or fictional).

Differences: This contest is typical of other one-time contests awarding winners with job or internship opportunities. The contest requires a creative writing as an example of writing skill and creativity. This contest does not use social media to evaluate candidates, is limited to college students and not a systematic method for sorting the best candidates.

Campbell Mithun—Twitter Submissions to Win an Interview

Link: http://www.nytimes.com/2011/03/25/business/media/25adco.html

Description: 425 candidates submitted a Twitter tweet for 13 straight days. Then a group of Campbell Mithun employees chose the best 32 for interviews.

Differences: This contest is typical of other one-time contests awarding winners with job or internship opportunities. The contest requires candidates to show off their social media and creativity skills. This contest is not a systematic method for sorting the best candidates for a job.

Interactive Brokers, Greenwich, Conn.—Investment Software Programming Competition

Link: http://www.forbes.com/2008/04/14/financial-jobs-investment-lead-careers-cx_ts_{—}0414contest_print.html

Description: Interactive Brokers created a competition whereby investment software engineers designed software to invest one million dollars. Over 400 candidates entered the contest and the winner received a job offer with Interactive Brokers.

Differences: This competition is narrowed to the field of software programming and the winner is determined by the outcome not the number of votes like competition based hiring. This system evaluated outcome not overall candidate talent and is mostly luck-based in terms of the outcomes.

XFinity Sports Social Media Reporter—Video Entry Why You?

Link: http://www.sbnation.com/2012/3/30/2914069/xfinity-ulitmate-sports-social-media-job-contest-austin-schindel

Description: Video entry describing why you are the best candidate for the social media sports reporter for XFinity. The entry is voted on by Facebook users on a 100 point scale with five 20 point categories; creativity, uniqueness, personality, sports knowledge and passion. The top 20 vote earners are flown to a location where judges will evaluate their chronicling the finalist experience through Facebook and Twitter. The winner receives a job as the XFinity

Sports Social Media Reporter.

Differences: This contest used social media to gain votes but using the Facebook platform not a specialized platform. The contest is for a single position and uses video entries only. The final judging is conducted by industry professionals not the social media tool. XFinity must hire the competition winner whereas competition based hiring produces a ranked list of the best candidates from which the company interviews and chooses.

JND Technologies—Computer Programming Competition for Internship

Link: http://www.techtalkz.com/programming/5093-web-2-0-coding-competition-prize-internship.html

Description: Programming competition where contestants are given an objective to achieve using computer programming techniques. No set criteria for the winner was stated.

Differences: Not a systematic method for identifying talent but a single competition showing off computer programming skills for an internship. JND Technologies must hire the competition winner whereas competition based hiring produces a ranked list of the best candidates from which the company interviews and chooses.

Monster Energy—Ultimate Intern Contest

Link: http://contests.about.com/od/vacationsweepstakes/p/120601-monster-energy-ultimate-intern-contest.htm

Description: To enter, submit a video describing why you deserve to be a Monster Intern. All of the entries will be put up for public vote. Judges will select six finalists on the basis of originality, effective depiction of why the contestant should be the Monster Energy ultimate intern, and the scores of the video submissions from open voting. The six finalists will compete for the role of intern in a series of events at various Southern California locations, which may involve athletes, music artists, celebrities and Monster Energy staff. The judges will select the two winners from among the six finalists on the basis of demonstrated professionalism, ability to complete the tasks assigned in a manner consistent with the quality of work expected of Monster Energy employees, and personality and ability to demonstrate understanding of the Monster Energy brand and lifestyle.

Differences: This is a one-time contest designed to promote Monster Energy drink and select a Monster Energy intern. The contest does not use social media to select candidates but instead uses judges. The contest is not designed to produce a ranked ordered list of candidates based on talent but instead produce six finalists from which two will be chosen. This is not a systematic means to filtering the best candidates for a given employment opportunity. This is mostly a marketing exercise. The number of steps and “events” associated with the contest make it more of a spectacle instead of a repeatable, valid hiring method. It is also hosted and sponsored by the employer. The present method is creating a streamlined platform to host job-skills competitions for any company.

### SUMMARY OF THE INVENTION

The present invention relates to a competition-based method of ranking job candidates. Employers have a number of options and techniques to search, assess and hire new employees. All of them are still widely acknowledged to have a high margin for error. Among those options and techniques are interne based hiring websites and paid candidate searches. To date, hiring websites and candidate recruiters have not used a job specific competition method for filtering the best candidates.

Methods for searching and filtering the best candidates vary. Some methods include psychometric evaluations, behavioral interviewing, predictive algorithms, and demographic filtering/matching along with other personality, education and demographic based hiring methods. None of these methods speak directly to the question, “how can an employer know who are the most talented and specifically qualified candidates for this particular job with these particular job skill requirements?” before hiring the candidate.

The present invention includes the following interrelated objects, aspects, and features:

(1) The present invention is a software and/or web-based method enabling employers to determine which candidates are the most talented as it relates to a specific job capabilities. Specifically this competition based hiring method takes a pre-existing pool of job seekers and allows them to enter talent based competitions to win prizes and more important job interviews and ultimately jobs. Employers then receive a list ranking of the most talented candidates for any given job.

(2) There are several advantages to this system. First, the competition method only attracts highly interested candidates in that particular job. Many of the “more sophisticated” web or software solutions are just searching a universe of resumes or profiles to produce potential matches. These “matches” do not guarantee that the “match” is even interested in the job or even looking for a job. So the competition provides an initial filter where only the most interested candidates are in the pool of applicants.

(3) Also, because there are prizes associated with the contest, there are additional incentives for those talented folks to participate in the contest which will help to ensure a higher volume of candidates for the position. In addition, the prizes may attract candidates who would otherwise not have been interested in that particular job which may broaden the search to include applicants with a wider array of talents or skills that the employer may never have seen or computer matching may not have uncovered.

(4) Most importantly, however, this competition-based system will produce the best candidates that have the particular and specific skills necessary for the actual job and will allow the employer to actually see those skills in action during the selection process. The computerized system is enabled to allow employers, other users, third party professionals or some combination of the above to vote and/or judge the best candidate entries, which gives additional flexibility in the structure of the contests.

(5) For example, certain contests like graphic design for an advertising agency would lend itself to publicly-judged contests whereas a contest for a software developer would be better judged by someone with those particular skills within the Company or the IT department of the Employer.

(6) Ultimately, it is a much more streamlined and efficient “try before you buy” system for employers of any type, size, etc. Employers get to see candidates in action doing relevant work and view virtual profiles of the candidates with additional samples of their work product all before the candidate is actually hired. This information will allow the employer to make a much more efficient and informed hiring decision.

Accordingly, it is a first object of the present invention to provide a competition-based method of ranking job candidates.

It is a further object of the present invention to provide such a method in which web-based media are employed to allow screening of job candidates.

It is a still further object of the present invention to provide such a method in which incentives such as prizes are offered to those willing to submit their credentials concerning a particular job that has been made available.

It is a still further object of the present invention to provide such a method which is specifically designed to produce the best candidates that have the most appropriate, particular and specific skills necessary for the actual job that is being offered.

These and other objects, aspects and features of the present invention will be better understood from the following detailed description of the preferred embodiment when read in conjunction with the appended drawing figures.

### BRIEF DESCRIPTION OF THE DRAWINGS

FIGS. 1A-D combine together to show a detailed flowchart of the manner of practice of the inventive method.

FIG. 2 shows the manner by which FIGS. 1A-D are combined together to create the flowchart.

FIG. 3 shows a schematic diagram of a portion of the sequence of events undertaken in practicing the inventive method.

FIG. 4 shows a further diagram showing further steps undertaken in practicing the inventive method.

FIG. 5 summarizes the steps shown in FIGS. 3 and 4.

FIGS. 6-13 show screen shots of the various pages of the website at the heart of the inventive method.

FIG. 14 shows a schematic representation of the hardware utilized in practicing the inventive method.

### SPECIFIC DESCRIPTION OF THE PREFERRED EMBODIMENT

As explained above, the present invention is a software and/or web-based method that enables employers to determine which job candidates are the most talented as relates to a specific job. The present invention contemplates taking a pre-existing pool of job seekers and allowing them to enter a talent-based competition to win prizes and more importantly to conduct job interviews and ultimately be hired. Employers receive a list from a server ranking the most talented candidates for any given job.

The present invention is practiced (FIG. 14) using a computer on which software is uploaded, the computer having input means such as a keyboard, and a display, and the computer being connected via a server to the global computer network known as the Internet so that job candidates can communicate with the server via the Internet in practicing the inventive method. The display can display the website used in practicing the invention. Authorized third parties including website administrators, employers and job candidates can gain access to the website including via the Internet.

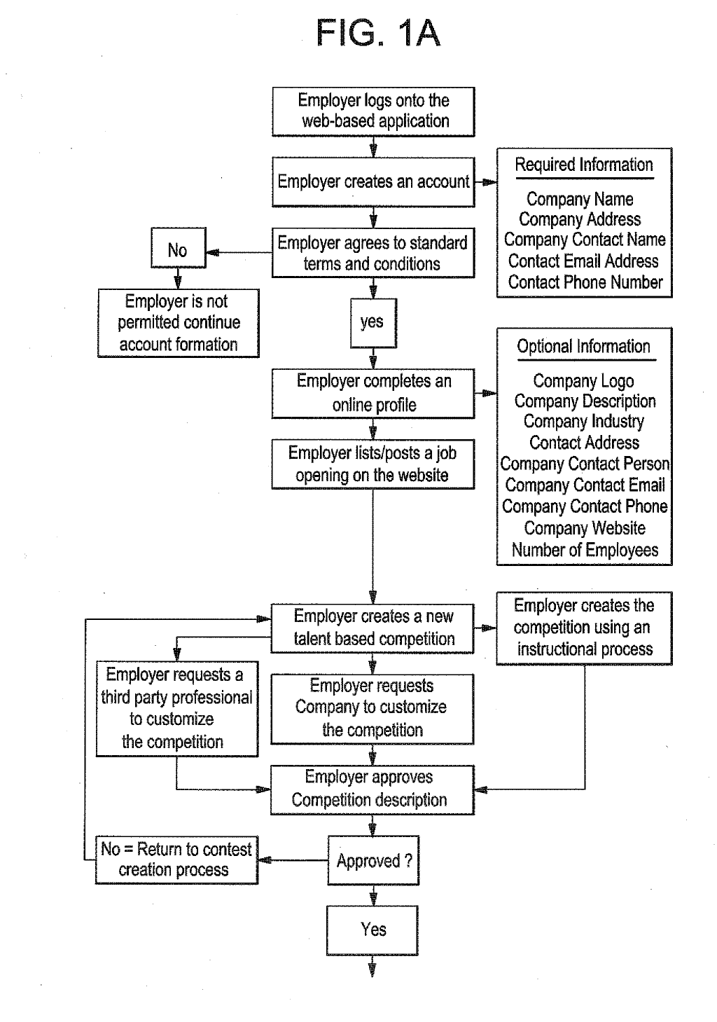

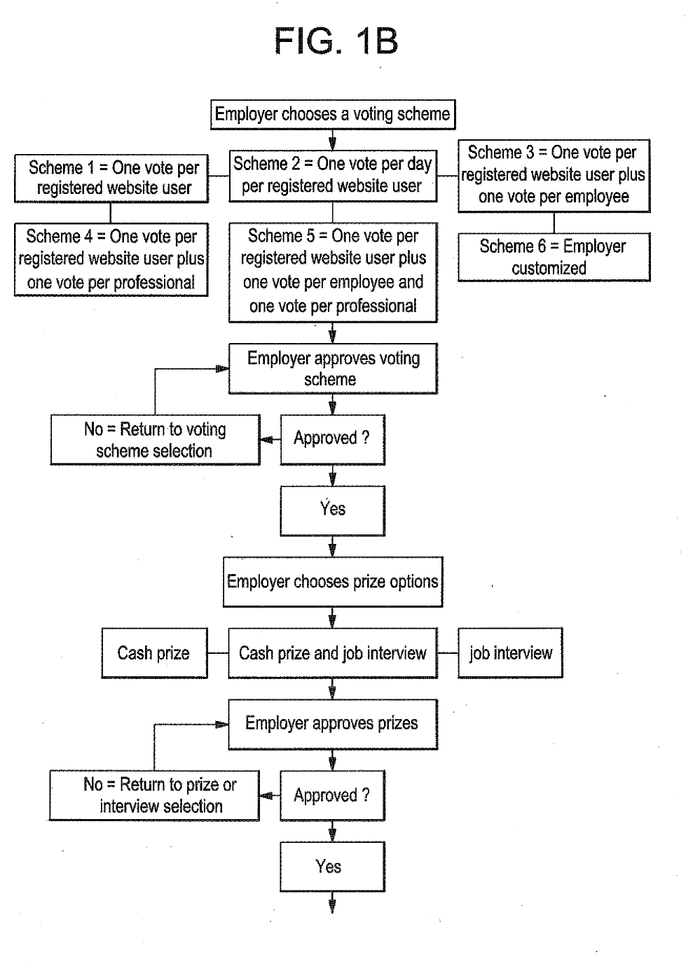

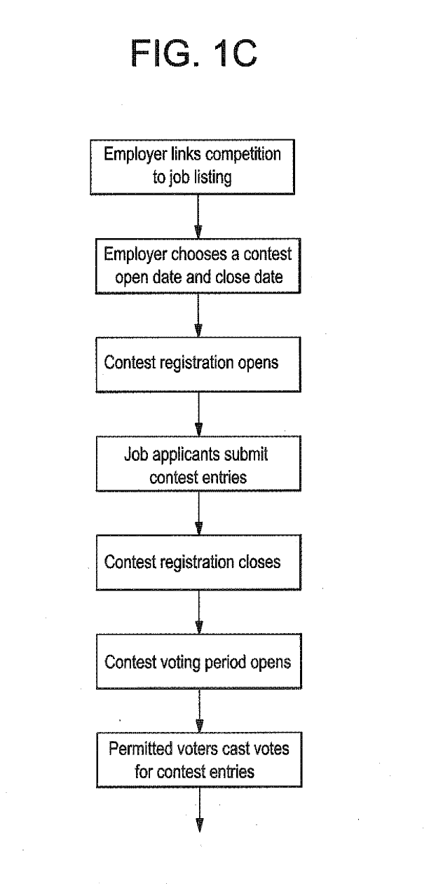

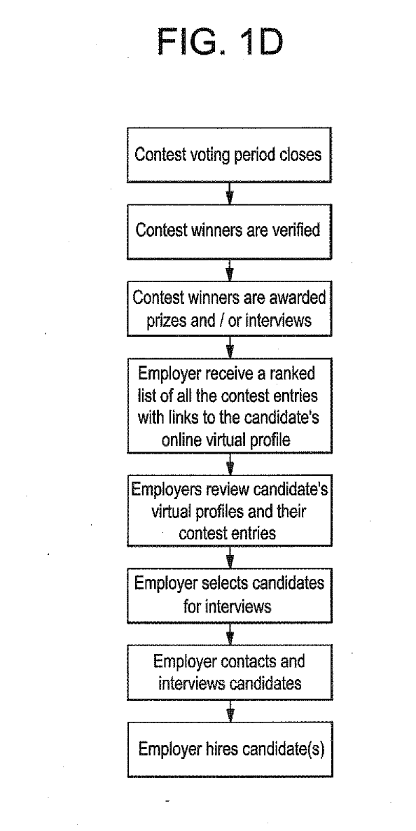

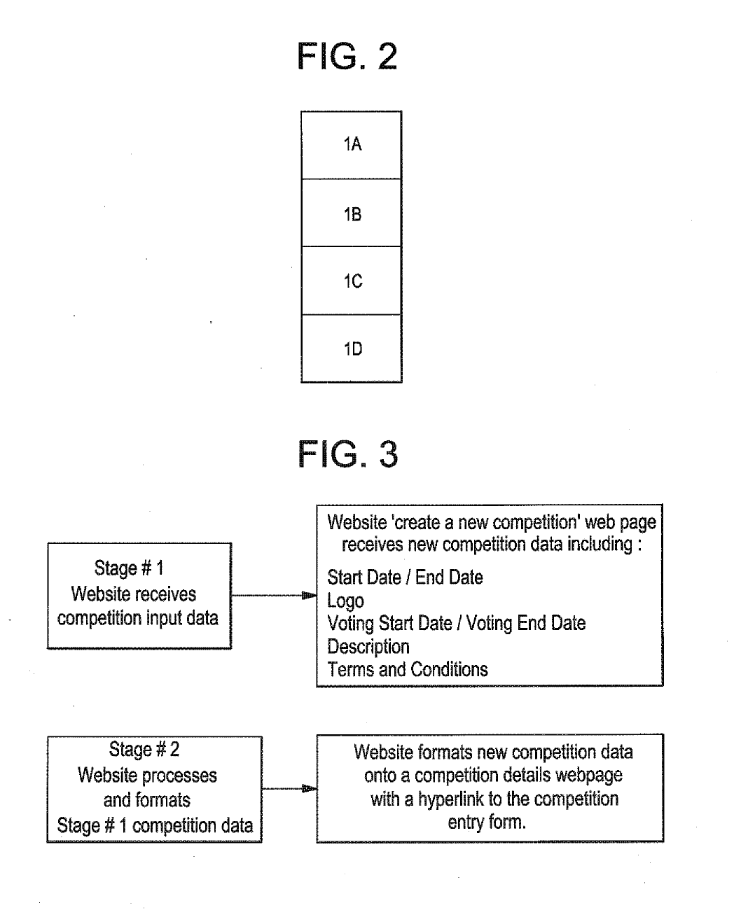

With reference to FIGS. 1A-1D which are assembled together as shown in FIG. 2, an explanation of the preferred manner of practice of the inventive method will now be described.

With reference first to FIG. 1A, the employer logs onto the web-based application and creates an account including the required information such as the company name, address, contact information, etc. The employer agrees to the standard terms and conditions of the operator of the web-based application. As shown, if the employer does not agree to those terms and conditions, the employer is not permitted to form an account.

Once the account is formed, the employer completes an online profile including the optional information listed such as company logo, description, industry of interest, contact information, number of employees, and perhaps a link to the website of the company. Once this has been completed, the employer can list and post job openings on the website.

Thereafter, the employer is able to create a new talent-based competition and may request the operator of the web-based application to customize the competition for that particular employee. This may include reliance upon third party professionals and may include use of an instructional process. Once the competition description has been approved by the employer, the employer can choose a manner of voting on job candidates. If the employer has not approved the competition description, the creative process is resumed until the employer is satisfied.

With reference to FIG. 1B, once a voting scheme has been chosen among the six options shown in FIG. 1B, and the employer has approved the voting scheme, next, the employer chooses prize options. These prize options can include cash, gifts, and other types of prizes as desired. One option for the voting scheme is a customized voting scheme as particularly desired by the employer. This customized option may be employed at the option of the employer. Once the particular voting scheme has been approved and the prizes to be granted have been approved, the next step is linking the competition that has been created to the job listing that was provided. Thereafter, the employer chooses the dates of opening and closing for the competition and contest and the operator of the inventive method opens contest registration. Job applicants who have visited the operator's website may see the prospective jobs and view the metes and bounds of the competition. Job applicants may submit contest entries in accordance with the parameters of the website.

At the date of closing of the contest, the contest voting period opens, and people and entities authorized to cast votes for contest entries may then do so.

With reference to FIG. 1D, on the date agreed upon for the voting period to close, the voting period closes and the votes are tabulated with the operator of the inventive method and website verifying contest winners. The contest winners are then awarded the pre-determined prizes and/or are granted job interviews.

The operator of the method provides the employer a ranked list of all of the contest entries with links to a virtual profile provided online by each job candidate. Employers can review each candidate's virtual profile and their contest entries.

With all of this information in hand, the employer selects candidates for interviews, contacts the prospective employees, and interviews them. Finally, the employer makes a decision on who to hire and may, at their discretion, hire that candidate.

The interactive website provides a means for filtering and ranking job candidates based on their actual job skills and capabilities. The website features a user-friendly interface populated with job candidates and employer profiles all connected by a central database.

The website offers corporate users the ability to create an online company profile. Corporate users then can more efficiently and effectively source job candidates by utilizing the website competition hiring method. Employers use the website competition design tools to create and host skills based competitions to better rank and narrow the job candidate pool. Employers can choose minimum participant qualifications, competition specs, contest registration and active period length, and voting/evaluation methods. The website also provides a portal to connect employers to each of the contest participants/job candidate's virtual profiles to provide an additional talent scouting or preview mechanism which provides more information to further help employers with the hiring decision. The portal will also include direct communication links with each of the competition participants.

The website attracts job candidates by offering virtual user profiles, forums and groups to allow users to connect and collaborate with other users. Users will also have access to job listings and talent based contests for interviews and cash prizes. The website uses a series of questions facilitating the creation of dynamic virtual profiles with traditional resume data in addition to other professional information, videos of the user, and work samples.

The website creates a dynamic online environment that allows individual users to showcase their individual talents in a new and more effective way. This attractive dynamic profile is a technological advancement over the resume. The ability to create and share these enhanced professional profiles with employers and other peers while competing for jobs is an attractive alternative from ubiquitous jobs board websites.

The competition method of the present invention is a unique new tool that combines all of these elements—easy user interface to create an employer account, dynamic new user/job candidate virtual profile, intuitive competition hosting platform, multiple contest judging criteria, and further analysis of virtual profiles as part of the final selection process for employers upon completion of each contest.

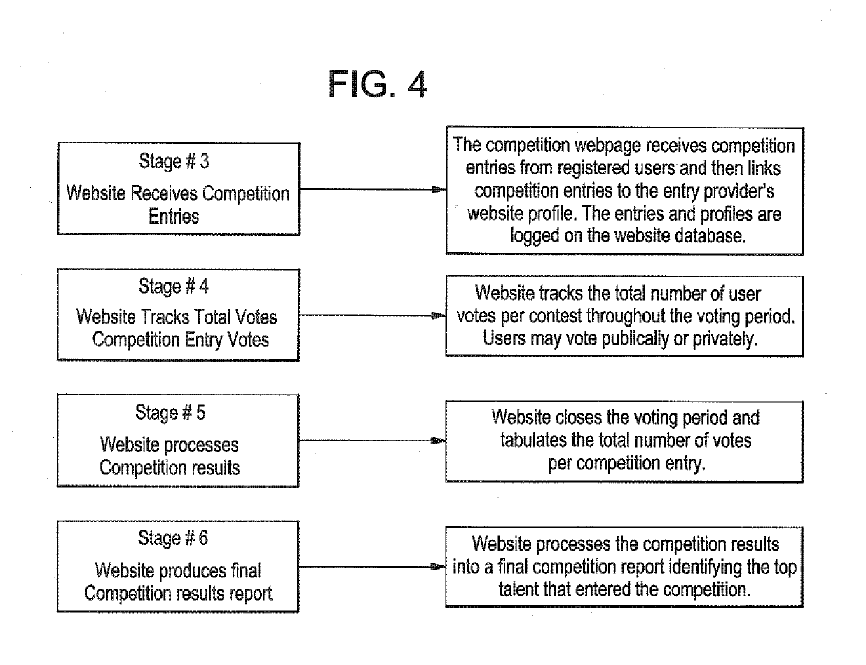

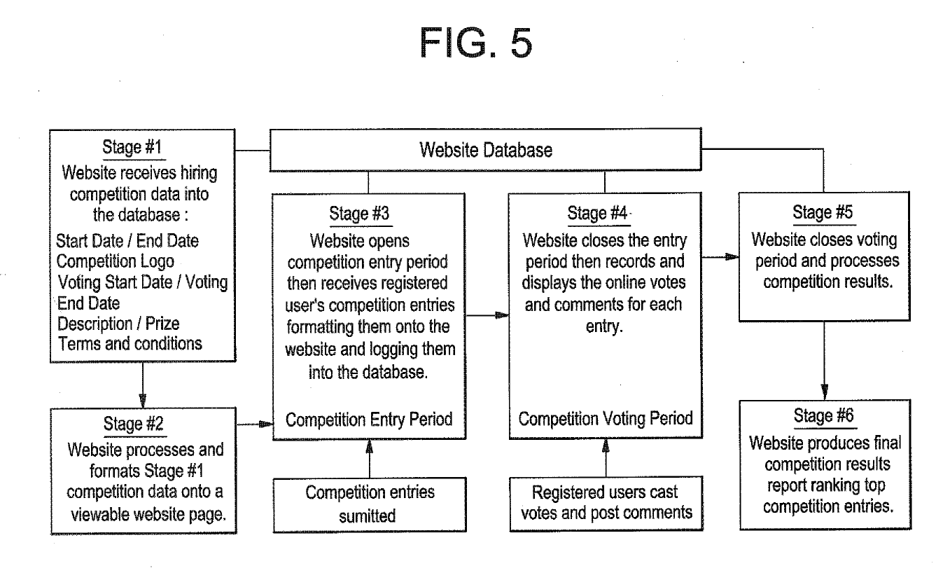

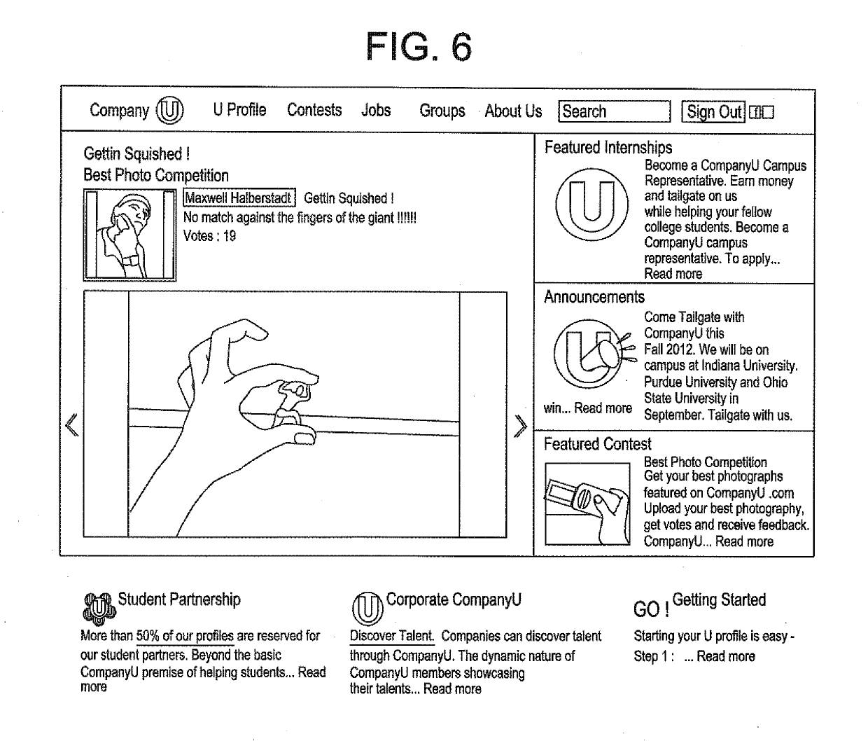

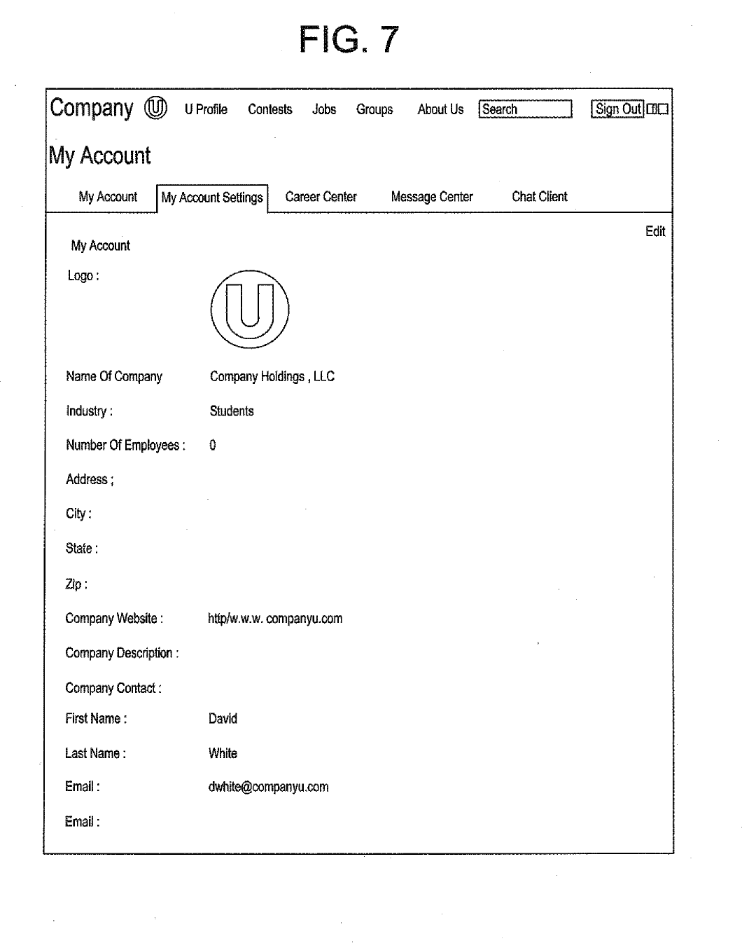

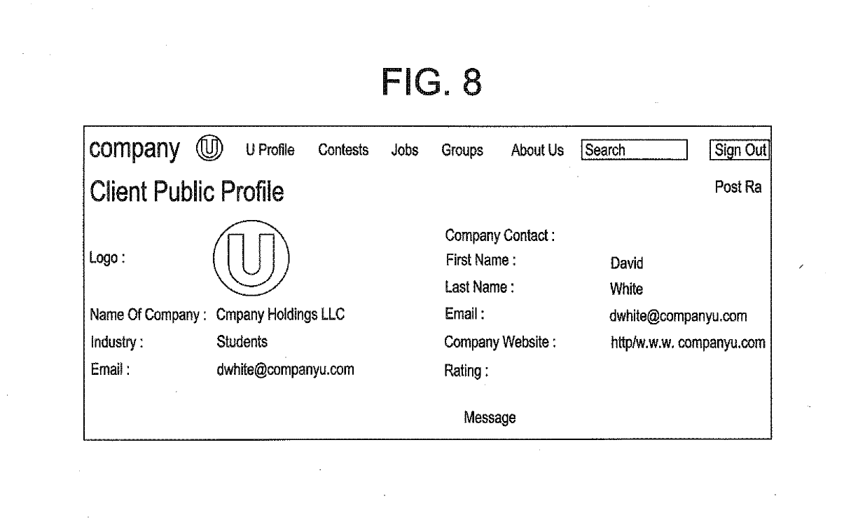

With reference to FIGS. 3-13, the website and connected database facilitates the creation of online employer profiles. A “main page” (FIG. 6) includes “buttons” that may be “clicked” to facilitate access to other pages and functions of the website. The employer profile creation process page (FIG. 7) collects data through a series of online forms gathering information about the employer including—name, company description, logo, web address, address, phone number email and contact person. This page is accessed by clicking on button 11 (FIG. 6). The employer clicks on the “SUBMIT” button 13 to save the information. The website then uses this information to display employer profiles to the public (FIG. 8). The display page is accessed by clicking on button 15 (FIG. 6).

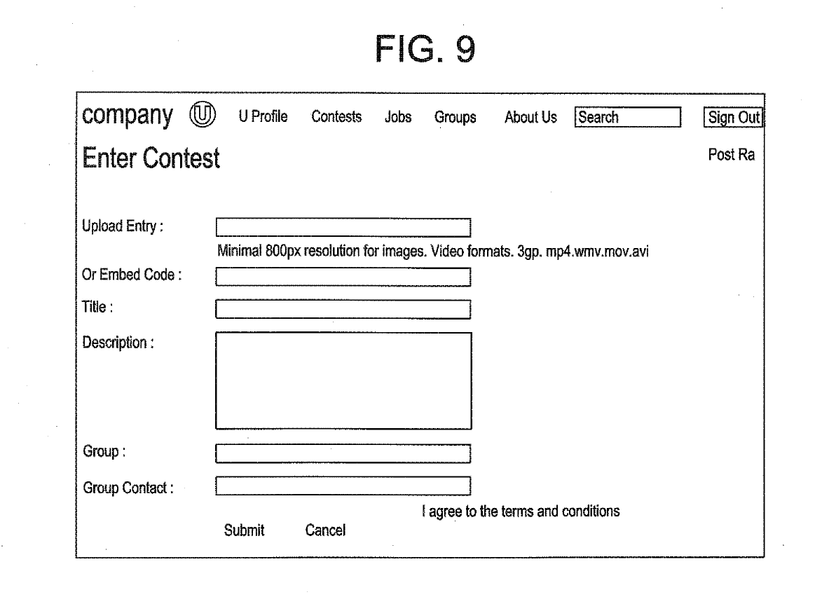

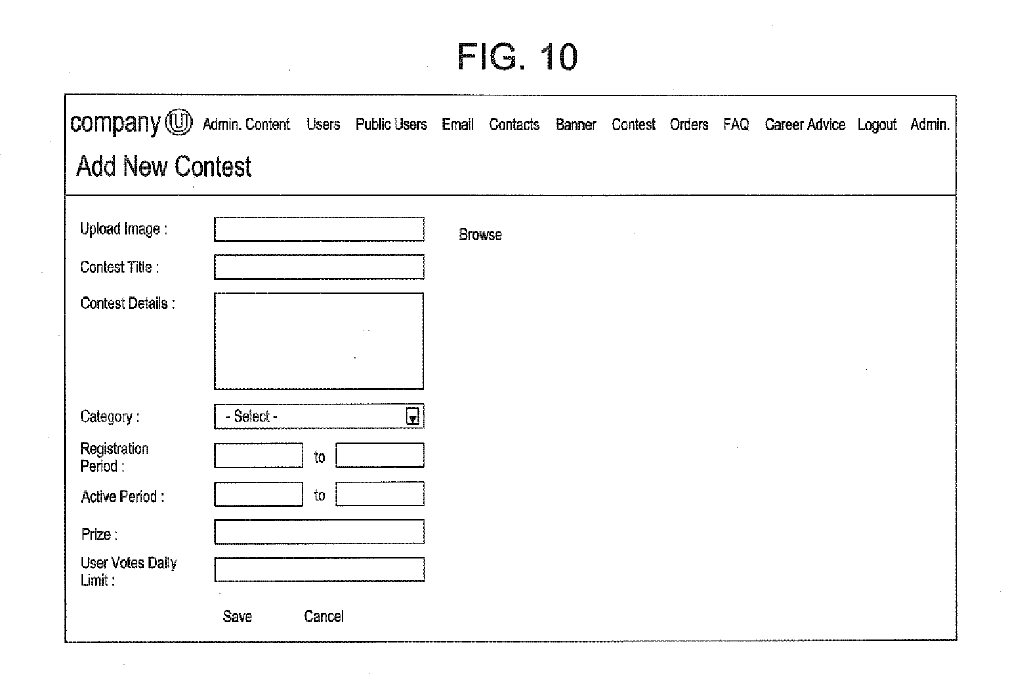

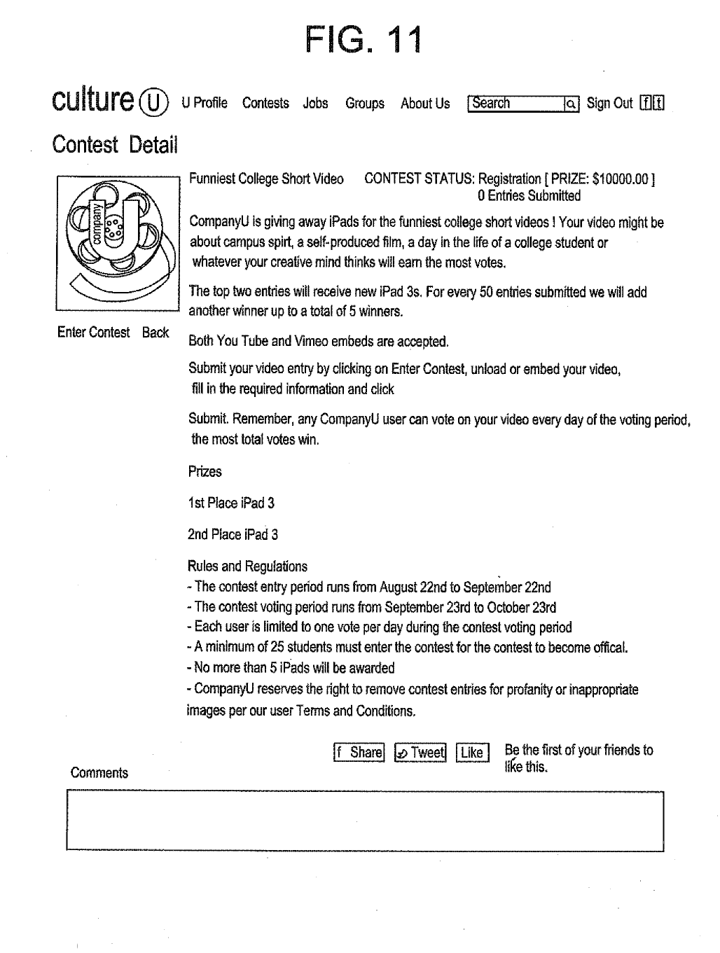

The website then assists employers in creating skills based competitions (FIGS. 9 and 10) by using a series of online forms to collect specific contest information including; a description of the contest challenge, the terms and conditions of contest, contest entrant restrictions or minimum qualifications, prize details, and the voting or evaluation methodology. The specific steps are as follows:
1. The website displays a new contest entry form (FIG. 9) accessed by clicking button 17 (FIG. 6).
2. The website collects information about the contest title, description, terms and prizes, by the user filling out the form and clicking on the “SUBMIT” button 19 (FIG. 9).
3. The website collects information about the registration/voting periods, and voting/evaluation methodology (FIG. 10), by the user filling out the form accessed by clicking button 21 (FIG. 6) and clicking on the “SUBMIT” button 23 (FIG. 10).
4. The employer selects public or private competition status (FIG. 10). Private competitions are only viewable by the company and the participants.
5. The website hosts the contest online in a unique contest room or webpage (FIG. 11) allowing candidates to make contest submissions. The contest room is accessed by clicking on button 25 (FIG. 6).
6. The website saves the information in a database.

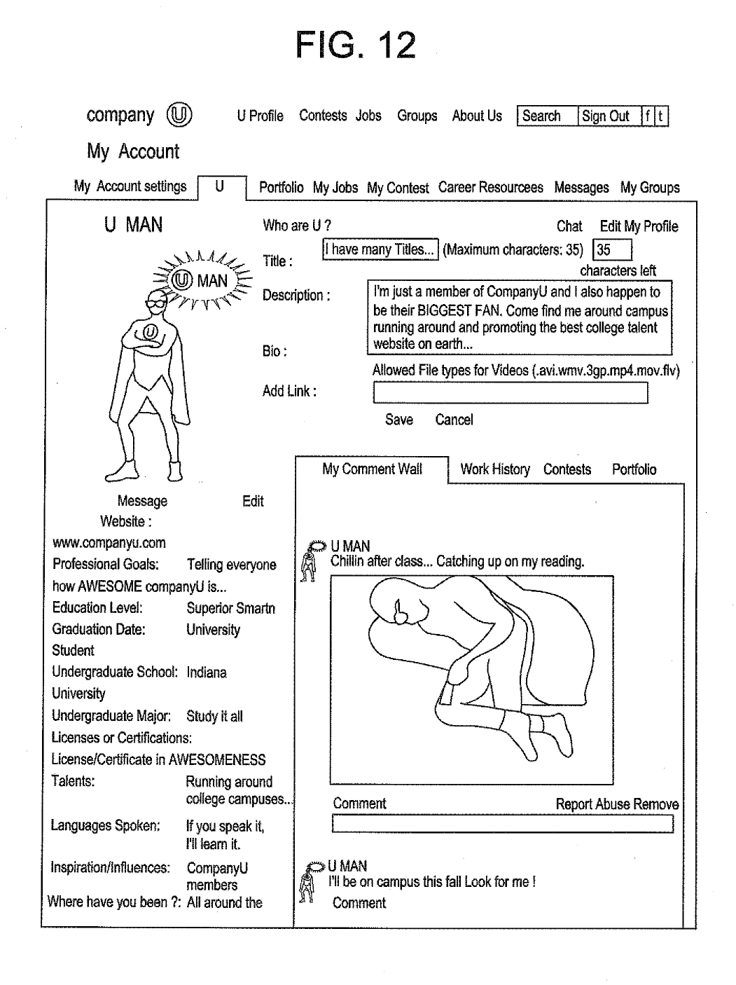

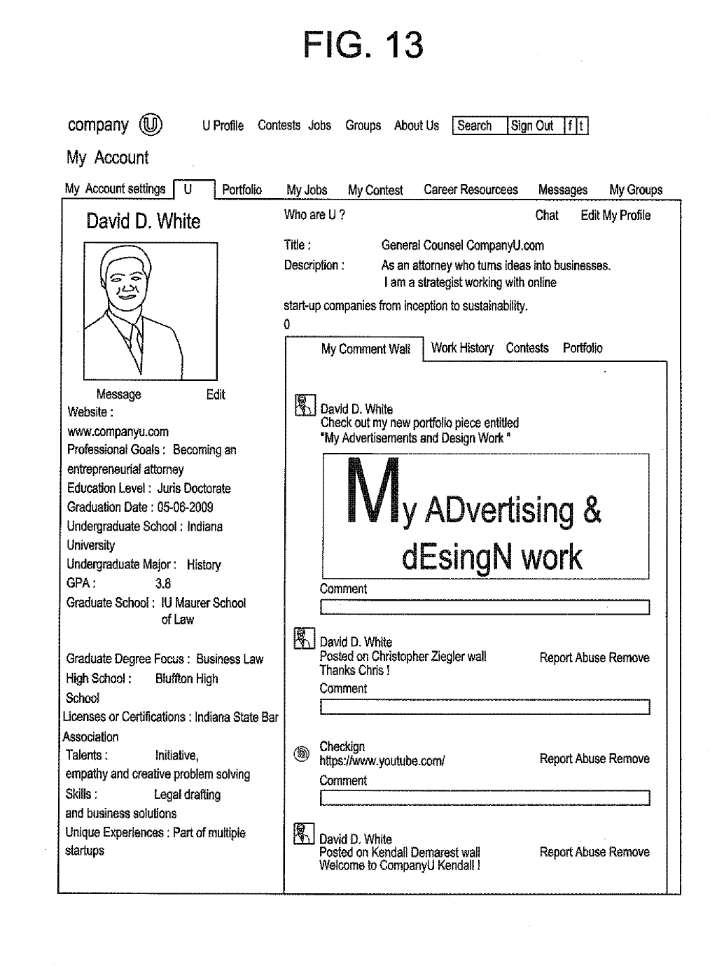

The website allows job candidates to create virtual profiles (FIG. 12) including name, personal bio, demographic info, personal videos & pictures, education history, work history, work examples, professional licenses, professional goals and other relevant information. The virtual profile creation page is accessed by clicking on button 27 (FIG. 6). Clicking the “SUBMIT” button 29 saves this information. The website then displays the job candidate's dynamic virtual candidate profile online (FIG. 13) when button 31 (FIG. 6) is clicked.

The website then enables registered job candidates to search for employer created contests by clicking on a search box 33 or entering contest room (FIG. 11) by clicking on button 25 (FIG. 6). The contest home page (FIG. 11) will have a list of all the competitions in an organized and searchable manner with a keywords search box. After collecting the keywords the website then queries the database for the most relevant contests and displays them to users in the order of relevance.

The website then collects contest entry information from the user (FIG. 9). The job candidate/user enters the contest by accepting the contest terms and conditions and uploading a contest entry file and any other relevant information required by the specific rules of the contest. The contest entry file can take the form of video files, picture files, and a wide range of document and other file types. Upon entry each contestant's user profile is also linked to the contest. The website tracks when the contest entry was submitted allowing entries during the contest registration period only.

Each individual contest has its own contest room (FIG. 11) (web page) for hosting. Included in the contest room are details of the contest such as prizes and rules, a list of all entries that can be viewed and voted or evaluated, a contest leaderboard, and links to each entrants' virtual profile. After the voting/evaluation period ends the website ceases to allow further voting. The website then tabulates the total number of votes and enables companies to select contest winners and a final order of placement in the contest.

The website tracks contest entries ranking them based on their total number of votes or other evaluation criteria specified by the company and itemized in the contest rules. The website displays the candidate profile, the contest entry, and the total number of votes per entry (FIG. 6 “RESULTS” button 35). Clicking on the candidate profile displays the candidate's full public profile (FIG. 13) and clicking on the contest entry displays that entry in viewable format.

Voting is also enabled on the contest detail page (FIG. 11, “VOTE” button). Voting can be open to the public or restricted to private users. The company will select voting methodology (including who is allowed to vote and the number/frequency of votes) during the contest creation process (FIGS. 9-10). The contest detail page will then administer the voting process by enabling the appropriate individuals to vote for entrants.

Upon completion, contest information is then memorialized into a contest history or archive which can be viewed by clicking on the corresponding button (FIG. 11), and saved by the sponsoring company and the contest participant for future use. Prizes are viewed by clicking on button 39 (FIG. 6). The contest participant will receive participation and placement recognition on their virtual profile.

In this way, a method has been provided that permits a prospective employer to attract prospective employees who are induced to submit job applications and compete for a job. The operator of the website and of the inventive method advertises and promotes the existence of the website on any desired media and as a result both prospective employers and prospective employees are made aware of the existence of the website so that they can participate in an attractive and effective employee hiring process.

As such, an invention has been disclosed in terms of a preferred embodiment thereof which fulfills each and every one of the objects of the invention as set forth hereinabove, and provides a new and useful competition-based method of ranking job candidates of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method of ranking job candidates using human-based assessments, including the steps of:
a) providing a computer having a memory and including input means for inputting information, and a display, and loading said computer with software for operating said method;
b) providing a server connecting said computer to a global computer network;
c) providing a website accessible to said computer via said global computer network and server whereby said software facilitates displaying images from said website on said display, said website including:
i) a main page with links to secondary pages, clicking on said links facilitating access to said secondary pages;
ii) said secondary pages including:
A) a first page in which an employer can input information to create and register an employer profile;
B) a second page in which an employer can input information to create a contest;
C) a third page in which job candidates can input information to create and register a virtual profile;
D) a fourth page where profiles of job candidates who have won a contest may be displayed;
d) employers creating employer profiles on said first page by inputting said profiles into said computer memory via said server;
e) a website operator using said input means to save said employer profiles in said memory to register said employer profiles;
f) job candidates creating virtual profiles on said third page by inputting said virtual profiles including their background and credentials into said computer memory via said server;
g) said website operator using said input means to save said virtual profiles in said memory to register said job candidates;
h) at least one employer creating a skills-based contest, said contest being saved by said website operator in said memory by inputting said contest into said computer via said server;
i) facilitating access to said contest by registered job candidates including displaying said contest on said display;
j) registered job candidates competing in said contest and said computer saving, in said memory, results from said registered job candidates competing in said contest;
k) said website operator facilitating human-based assessments of contest entries provided by job candidates, said human-based assessments comprising a plurality of authorized voters voting on said contest entries; and
l) displaying on said display, on said fourth page of said website, job candidates who have won contests based upon said human-based assessments, display of said job candidates including identification of contest won by each respective winning job candidate and a ranking of contest entries.

2. The method of claim 1, further including the step of providing a fifth page on said website and displaying a plurality of employer profiles on said display.

3. The method of claim 2, further including the step of providing a sixth page associated with said second page, where an employer can specify registration and voting time periods and deadlines.

4. The method of claim 3, wherein said sixth page includes means for designating a contest one of public or private.

5. The method of claim 1, further including the step of providing a fifth page associated with said second page, an employer specifying registration and voting time periods and deadlines on said fifth page.

6. The method of claim 5, wherein said fifth page includes means for designating a contest one of public or private.

7. The method of claim 1, creation of a contest by an employer including the step of describing a job for which job candidates are competing.

8. The method of claim 1, wherein an employer profile includes employer name, address, telephone number, industry, and employer size.

9. The method of claim 3, wherein in addition to voting time periods and deadlines, said employer specifying number of votes within a time period.

10. The method of claim 3, wherein during said creating step, said employer choosing prize options.

11. The method of claim 10, wherein said prize options include a job interview.

12. The method of claim 1, further including the step of closing a contest after a pre-set time period.

13. The method of claim 12, wherein after a winner is chosen, providing a ranking list of all contest entries with links to respective job candidate profiles.

14. The method of claim 13, further including the step of displaying said ranking list.

15. (canceled)

16. A method of ranking job candidates using human-based assessments, including the steps of
a) providing a computer having a memory and including input means for inputting information, and a display, and loading said computer with software for operating said method;
b) providing a server connecting said computer to a global computer network;
c) providing a website accessible to said computer via said global computer network and server whereby said software facilitates displaying images from said website on said display, said website including:
i) a main page with links to secondary pages, clicking on said links facilitating access to said secondary pages;
ii) said secondary pages including:
A) a first page in which an employer can input information to create and register an employer profile;
B) a second page in which an employer can input information to create a contest;
C) a third page in which job candidates can input information to create and register a virtual profile;
D) a fourth page where profiles of job candidates who have won a contest may be displayed;
E) a fifth page on said website where a plurality of employer profiles may be displayed on said display;
F) a sixth page associated with said second page, where an employer can specify registration and voting time periods and deadlines;
d) employers creating employer profiles on said first page by inputting said profiles into said computer memory via said server;
e) a website operator using said input means to save said employer profiles in said memory to register said employer profiles;
f) job candidates creating virtual profiles on said third page by inputting said virtual profiles including their background and credentials into said computer memory via said server;
g) said website operator using said input means to save said virtual profiles in said memory to register said job candidates;
h) at least one employer creating a skills-based contest, said contest being saved by said website operator in said memory by inputting said contest into said computer via said server;
i) facilitating access to said contest by registered job candidates including displaying said contest on said display;
j) registered job candidates competing in said contest and said computer saving, in said memory, results from said registered job candidates competing in said contest;
k) said website operator facilitating human-based assessments of contest entries provided by job candidates, said human-based assessments comprising a plurality of authorized voters voting on said contest entries; and
l) displaying on said display, on said fourth page of said website, job candidates who have won contests based upon said human-based assessments, display of said job candidates including identification of contest won by each respective winning job candidate and a ranking list of all contest entries with links to respective job candidate profiles.

17. The method of claim 16, wherein said sixth page includes means for designating a contest one of public or private.

18. The method of claim 16, creation of a contest by an employer including the step of describing a job for which job candidates are competing.

19. The method of claim 16, wherein in addition to voting time periods and deadlines, said employer specifying number of votes within a time period.

20. The method of claim 16, further including the step of closing a contest after a pre-set time period.
